(19) United States
(12) Patent Application Publication
(10) Pub. No.: US 2006/0206423 A1
(43) Pub. Date: Sep. 14, 2006

(54) System and method for registering commodities using an electronic warehouse receipt

(75) Inventors: Donald F Sternard, Clarendon Hills, IL (US); Richard J Crilly, Downers Grove, IL (US); David A Jonas, Naperville, IL (US); Eileen Haggerty, Chesterton, IN (US)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: The Clearing Corporation, Chicago, IL (US)

(21) Appl. No.: 10/541,914

(22) PCT Filed: Jan. 13, 2004
(86) PCT No.: PCT/US04/00772

§ 371 Date: Apr. 18, 2006

Related U.S. Application Data
(60) Provisional application No. 60/439,770, filed on Jan. 13, 2003.

(51) Int. Cl. G06Q 40/00

(52) U.S. Cl. 705/40

(57) ABSTRACT

Shown is a system for generating and managing of electronic warehouse receipts, where each receipt represents a right to delivery of a predetermined amount of a commodity from an undifferentiated bulk of the commodity. At the request of a buying party to a transaction, the system generates an electronic warehouse receipt from the transaction. The receipt is maintained in an account in a database, where the account corresponds to the buying party and where residence of the receipt in the account represents ownership of the receipt by the party owning the account. At the request of an account owner, the receipt may be transferred to an account corresponding to another party so that a trade of the commodity may be reflected in a change in ownership of the receipt. Each party may view the inventory of electronic warehouse receipts in its own account. Transfer of money may also be tied to transfer of the electronic warehouse receipt. Financial checks may be performed before generating an electronic warehouse receipt to prevent a shipping party from exceeding predetermined financial conditions in its trading activity.

### CROSS-REFERENCES TO RELATED APPLICATION

This application claims priority to co-pending U.S. patent application Ser. No. 60/439,770 filed Jan. 13, 2003, which is incorporated herein by reference in its entirety for all purposes.

### FIELD OF THE INVENTION

This invention pertains to a system and method for maintaining and transferring information using an electronic warehouse receipt (EWR).

### BACKGROUND OF THE INVENTION

Conventional systems for trading commodities typically involve trading systems for trading commodities of a unique nature. U.S. Pat. Nos. 5,285,383 and 5,063,507 to Lindsey et al., herein incorporated by reference in their entirety for all purposes, show an example of a commodity trading system for trading cotton. The commodity trading system includes a centralized computer and a database. All unique information relating to a bale of cotton is stored in the database as a title flag. The title flag field of the file indicates whether the title or warehouse receipts to the cotton bale is in documentary or electronic form. The electronic representation of title eliminates the transferal of documentary type of title, which is traditionally mailed to various locations to follow the trading transactions. In addition, the commodity trading system allows individual contracts to be grouped or consolidated into blocks. The commodity trading system permits sellers to select commodities to be available for purchase and permits buyers to review commodities available for purchase and to execute a transaction between a buyer and seller.

### BRIEF SUMMARY OF THE INVENTION

One embodiment of a method for providing an electronic warehouse receipt, according to the present invention, includes generating an electronic warehouse receipt record for delivery of a unit of commodity owned by a first party and storing the electronic warehouse receipt in an electronic account corresponding to a first owner of the electronic warehouse receipt. The method also includes, responsive to an externally generated request, transferring the electronic warehouse receipt from the electronic account corresponding to first owner of the electronic warehouse receipt to an electronic account corresponding to a second owner of the electronic warehouse receipt.

The foregoing and other features and advantages of the system and method for maintaining and transferring information using electronic warehouse receipt will be apparent for the following more particular description of preferred embodiments of the system and method as illustrated in the accompanying drawings.

### BRIEF DESCRIPTION OF THE DRAWINGS

The above and other features and advantages of the present invention will become more apparent by describing in detail preferred embodiments thereof with reference to the following description, claims, and attached drawings in which:

FIG. 1 is a block diagram of an interface used to transfer trading position information from an electronic trading system to a clearing system according to one embodiment of the present invention;

FIG. 2 is a flow chart illustrating the electronic data flow steps according to one embodiment of the present invention;

FIG. 3 is a flow chart illustrating the electronic shipping certificates according to one embodiment of the present invention; and

FIG. 4 is a block diagram of a computer system architecture suitable for use with one embodiment of the present invention.

### DETAILED DESCRIPTION OF THE INVENTION

An electronic warehouse receipt (EWR) is an electronic title representing the ownership of commodities. An embodiment of an EWR system according to the present invention maintains a record of electronic warehouse receipts and transfer of an EWR in connection with the delivery of the commodities upon the expiration of futures contracts at a trading house, such as the Chicago Board of Trade, the MidAmerica Commodities Exchange, or another Clearing Party.

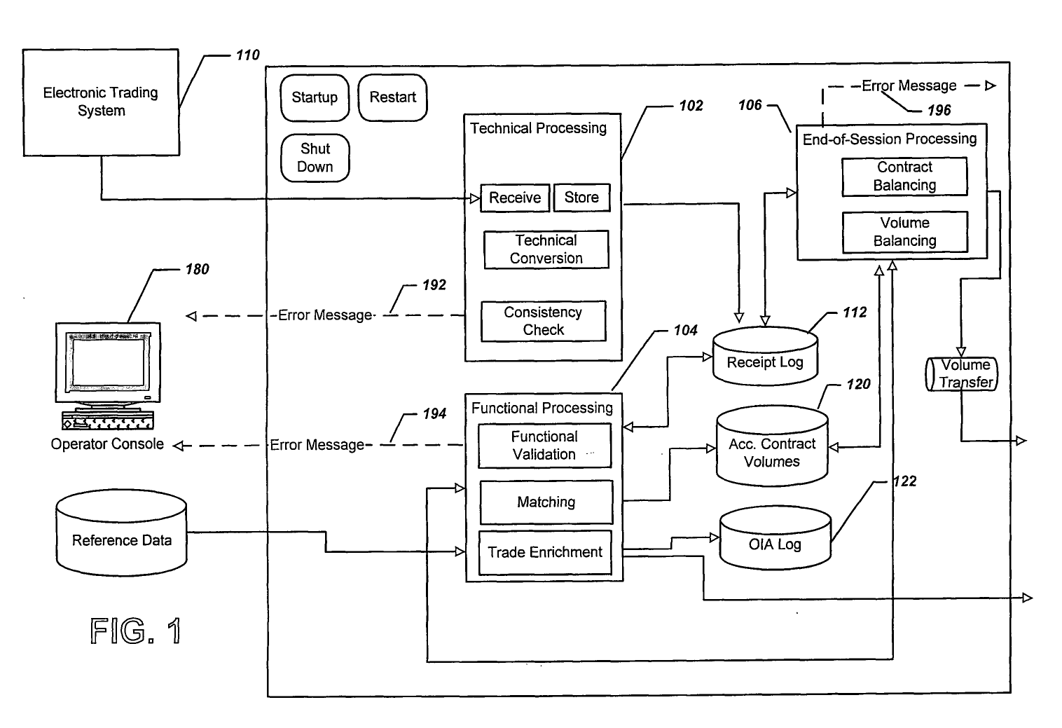

FIG. 1 is a block diagram illustrating an example of an interface used to transfer trading position information from an electronic trading system to an EWR clearing system in accordance with one embodiment of the present invention. The interface 100 includes three main processing components: a technical component 102, a functional component 104 and an end-of-day component 106. These components may take the form of separate processing units, e.g. multiple processors, or as different processes on the same machine, e.g. multi-processing, or a combination thereof.

The technical component 102 receives trading position information from an electronic trading system 110, ensures that the data is received in the proper sequence and stores the received trading position information in a receipt database 112. The technical component 102 further performs an important trade quantity calculation. Notably, the technical component 102 calculates the trading quantity from position information provided by the electronic trading system 110. As illustrated in FIG. 1, the technical component 102 receives trading position information from the electronic trading system 110. The electronic trading system 110 packages a plurality of records of trading position into a single transmission at defined time intervals and sends the records to the technical component 102. The technical component 102 may include a consistency check safety feature for verifying that all of the trading position records transmitted by the electronic trading system 110 are received by the interface 100.

The technical component 102 examines the sequence number of each record to ensure that the sequence number is continuously incremented by one for each record. The technical component 102 maintains a counter which tracks the expected sequence number and compares the expected sequence number with the received sequence number to ensure both sequence numbers match. If one ore more sequence number have been skipped, the record is stored in the database 112 and an error message 192 is output. If, on the other hand, the received sequence number is less than the expected sequence number, the record is discarded and an error message 192 is output. This sequence continues until the sequence number is equal to the expected sequence number, the record is then stored in the database 112.

Each trading position record is stored in the database 112 with an initial status of unmatched. The functional processing component 104 matches the trading position information on both buyer and seller trading records and generates, for example, either a Trade Exchange (TREX) buy record or a TREX sell record. The electronic trading system 110 assigns a corresponding transaction number to both sides of a given trade, which is used by the functional processing component 104 in matching and clearing the trades. The transaction records contain the seller and/or buyer position of a given account, and the technical component 102 calculates the trade (execution) quantity from the transaction seller/buyer quantities before the trading position information record is placed into the buy or sell table in the functional processing component 104 for matching.

The electronic warehouse receipt (EWR) System is a registry that will maintain a record of warehouse receipts and their transfer in connection with the delivery of commodities upon the expiration of futures contracts by the clearing party.

Futures contracts entered into using the facilities of the clearing party may be matched by the clearing party's core clearing system or by an electronic trading system as discussed above. “Long” and “short” contracts to make delivery and take delivery of the commodities underlying the contract are matched based on the characteristics of the futures contracts, e.g. type, grade and quantity of the commodity as well as the date for delivery. Once futures contracts have reached expiration without having been offset (typically less than 5% of contracts reach this point), remaining buyers and sellers are paired up to effect delivery of commodities underlying the futures contract through a warehouse receipt. Although this pairing process is sometimes referred to as “matching” buyers and sellers, it is distinct from, and unrelated to, the matching of trades that is executed through clearing party facilities.

Only after buyer and seller contracts are paired is the EWR system of the present invention utilized. The party that must make delivery on the contract (the “seller” or “short”) must obtain an electronic warehouse receipt in one of two ways. The short may obtain the receipt from a participating warehouse by contacting a clearing firm agent who has access to the EWR system and who, in turn, requests that a warehouse issue a new receipt for a unit of commodity in the name of the short party. Alternatively, the short may buy an existing receipt through a cash broker who is independent of the EWR system or through another clearing member and have his ownership of the receipt reflected in the registry of the EWR system. Note that it is possible for clearing members to transfer warehouse receipts independently of the delivery system of the EWR system. Thereafter, the EWR system effects transfer of an electronic warehouse receipt on the registry for the commodity at the warehouse to the party taking delivery, e.g. the “buyer” or the “long”, in exchange for payment by the long party, which the clearing party passes through to the short party.

According to a preferred embodiment, each clearing member views their own inventory of electronic warehouse receipts. View of other receipts owned by another member or offer to buy a receipt of another member using the EWR system may not be permitted. The EWR system allows information from the registry to be viewed that indicates the number of electronic warehouse receipts outstanding for a given warehouse as well as the identity of the firm that last made or took delivery on a receipt.

Purchase of an electronic warehouse receipt requires a party to contact the party who owns the receipt, either directly or through a cash broker, to negotiate and execute a purchase. The EWR system may be used to transfer ownership of the EWR on the registry.

Each electronic warehouse receipt in the EWR system represents a standard lot of a commodity, for example 5,000 bushels of grade A yellow corn. Commodity contracts may not be grouped for delivery.

According to another embodiment, the EWR system deals exclusively with commodities of a non-unique nature. The electronic warehouse receipt in the EWR system represents a right to delivery of a standard amount of a commodity of a given grade from an undifferentiated bulk of the commodity. For example, delivery on an electronic warehouse receipt for a contract on grade A yellow corn entitles the owner of the receipt to delivery of 5,000 bushels of grade A yellow corn at a grain elevator associated with the EWR. The corn that is delivered from the elevator may be any grade A yellow corn in the elevator's stores.

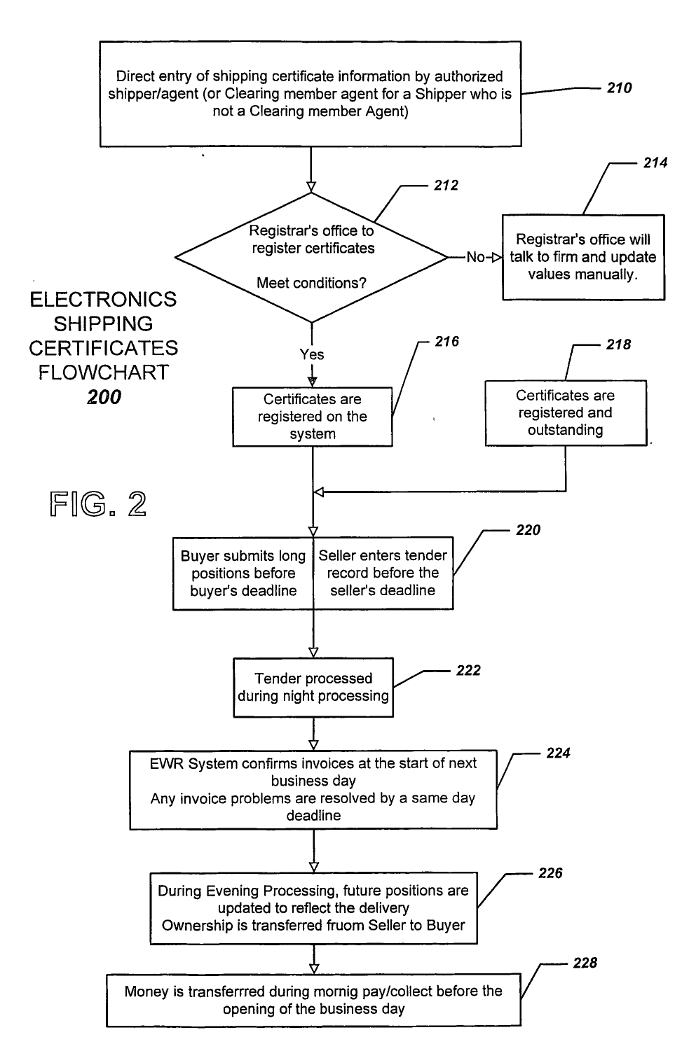

One embodiment of the current invention is described in the Electronic Shipping Certificates Flowchart Diagram FIG. 2. During the Direct Entry Step 210, shipping certificate information is entered into EWR Delivery System by the Clearing Member Agent of a shipper via terminal screens available within a Delivery Menu.

During the Financial Verification Step 212, The Registrar's Office, via web enabled screens, can view Shipping Certificate data that has been submitted for registration. The EWR Delivery System checks that financial conditions are met. Registration will not take place if any the order exceeds available credit, or the total number of allowed registered certificates for a shipping station is exceeded. Shipping certificates that are entered by the Shipper, if a Clearing Firm, or a Clearing Firm who is the Agent of a non-clearing shipper, will be available to the Registrar for registration. Registrar access will be via web enabled screens.

The EWR will perform various financial and operational readiness checks, based on input from the Registrar's Office. The Registrar will supply the system with the following information for each shipper:

The Letter of Credit Value (LOCV);

The Net Worth Value (NWV); and

The Operational Maximum Certificate Number (OMAX) for each shipping station.

The Registrar will have the ability to update these values during the processing day. For example, if a Clearing Member Firm attempts to register certificates and is constrained by their LOCV they may file a larger LOCV later that day and then register a shipping certificate later that same day.

The System will calculate the Current Market Value Estimate (TVCO) of the total registered shipping certificates currently issued for each shipper. For example:

The TVCO=(The total registered certificates of corn currently registered for the shipper×5,000×the last mark price (final or variation) for the corn futures contract with the nearest expiration)+(The total registered certificates of soybeans currently registered for the shipper×5,000×the last marked price (final or variation) price for the soybean futures contract with the nearest expiration).

The System will prevent registration of certificates if the registration will cause:

The TVCO to be >NWV×0.25;

The LOCV to be <TVCO; or

The total number of registered certificates for a shipping station to be >OMAX

During the processing day the system will alert the Registrar's Office of any Net Worth Deficiencies for all shippers where the TVCO is greater than the NWV×0.25 or the LOCV is less than the TVCO×1.0.

The Registrar will be able to Register all or part of Shipping Certificates that have successfully passed all financial and operational readiness checks. The Registrar's Office will be able to perform various monitoring functions. If the financial checks above are not met, the certificates can not be registered. The Registrar's Office can update the above values allowing the registration to take place during the Manual Update Step 214. If financial checks are met, the Registrar's Office may complete specified action to register the shipping certificates during Registration Step 216.

At Step 218, certificates that are already registered and outstanding are made available for consideration along with the certificates registered in step 216 in the following Step 220.

At the beginning of the delivery cycle, the Buyer submits long position data before a buyer deadline. The Seller enters tender or re-tender instructions before a seller deadline. These activities are part of the Delivery System Step 220.

During Tender Processing Step 222, transactions are processed overnight to be confirmed at the beginning of the next business day.

During Confirmation Step 224, The EWR System confirms the invoices at the opening of the business day. At this point Buyers are able to view invoices online. Invoice errors are typically resolved by a same day deadline.

During Final Evening Processing Step 226, The EWR System typically updates positions for both firms to reflect the delivery. The EWR System will process all Shipping certificates that are marked for delivery that day.

During the Pay/Collect Step 228, As part of the daily pay/collect bank processing before the opening of the business day, money will be transferred between the Buyer and Seller on the day of actual transfer of ownership of the certificates. On a banking holiday, transfers will be guaranteed by the bank using the currently used processes.

Steps 220 through 226 may be combined on the same day, if, for example, the transaction falls on the last delivery day of a cycle.

Inventory will automatically transfer from selling (short) to the buying (long) firm. The delivery system will support the capability to re-tender shipping certificates within the same exchange. Shipping certificates will not have an expiration date. Transfer of ownership of the electronic shipping certificates will take place as part of delivery processing during night processing in Step 226. Transfer of money between the Buyer and Seller clearing firms will take place before the start of the next business day and is part of the current pay/collect Step 228.

Loan transactions are executed external to the system. An electronic warehouse receipt that is to be used as collateral to a loan may be moved at the instructions of the owner of the receipt from the owner's account to an account associated with the creditor. When the receipt is released from being collateral, the creditor instructs the receipt to be moved from the creditor's account to the account of the owner or another owner. The EWR system does not receive requests for loans or cause checks to be issued.

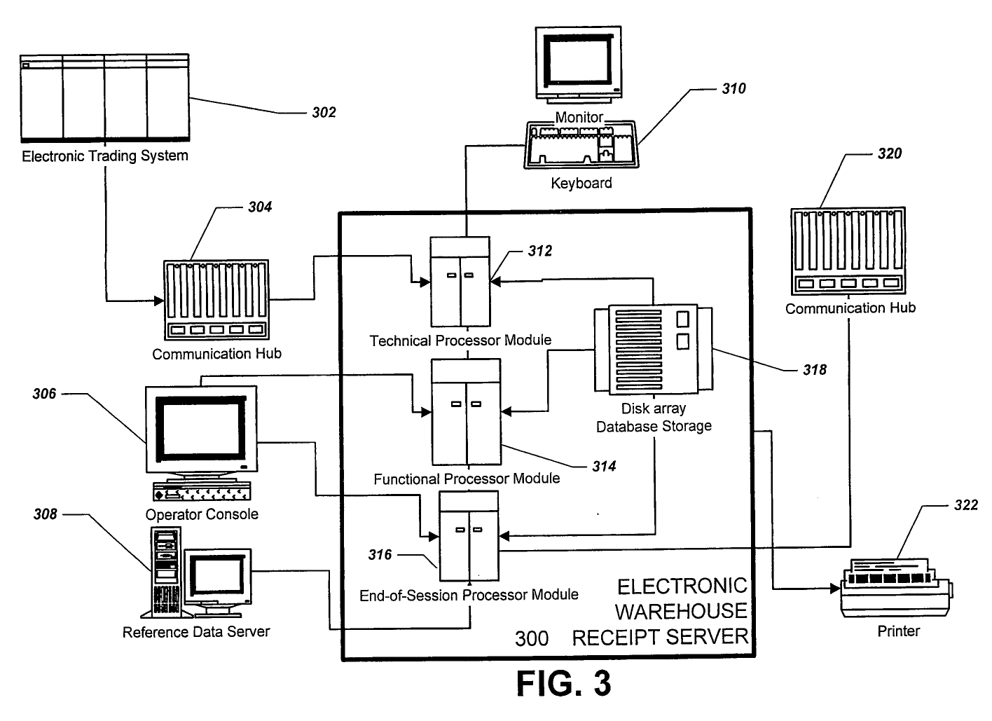

The embodiments of the present invention described above may also be viewed as a computer system for managing electronic warehouse receipts as shown in FIG. 3. The system includes a receipt database 318 for storing electronic warehouse receipts. The system contains either a processor or a process 312 within a computer that is configured (e.g. designed or programmed) to receive trading position data from an electronic trading system 302 and store each trading position record within the trading position data in the database 318 with an initial status of unmatched. A second processor or process 314 is configured to match buy and sell trade records in the database 318 and, for each matched trade, generate a transaction record for the trade. A third processor or process 316 is configured to receive a request for an electronic warehouse receipt from a first party corresponding to a buyer in one of the transaction records and, responsive thereto, generate an electronic warehouse receipt for a unit of commodity corresponding to the transaction record, where the electronic warehouse receipt is stored in the receipt database 318 in a first account corresponding to the first party. In this computer system, the third processor or process 316 may be further configured to receive a transfer request from the first party indicating transfer of the electronic warehouse receipt from the first party to a second party and, responsive thereto, transfer the electronic warehouse receipt from the first account to a second account corresponding to the second party. In this computer system, the transfer of the electronic warehouse receipt from the first account to the second account may represent transfer of legal ownership of the electronic warehouse receipt.

Furthermore, in this computer system, the third processor or process 316 may be further configured to perform a predetermined financial check, such as the one described above with regard to TVCO, before generating the electronic warehouse receipt and where the electronic warehouse receipt is generated only if the financial check passes. As discussed above, the predetermined financial check may be based upon reference data from a separate database 308 regarding a financial condition of a shipping party and all electronic warehouse receipts in an account corresponding to the shipping party.

Also, the third processor or process 316 means may be configured to process a series of transaction requests involving many electronic warehouse receipts belonging to different parties and, for each transaction, transfer the electronic warehouse receipt in each transaction to an account corresponding to a buying party of the transaction. This processing may also involve transferring money from the buying party to a selling party of each transaction. To facilitate such transfers, the computer system may be designed so that each party is enabled to electronically view all electronic warehouse receipts residing in the account corresponding to the party.

All references, including publications, patent applications, and patents, cited herein are hereby incorporated by reference to the same extent as if each reference were individually and specifically indicated to be incorporated by reference and were set forth in its entirety herein.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A method for providing an electronic warehouse receipt, the method comprising:
generating an electronic warehouse receipt record for delivery of a unit of commodity owned by a first party;
storing the electronic warehouse receipt in an electronic account corresponding to a first owner of the electronic warehouse receipt;
responding to an externally generated request, transferring the electronic warehouse receipt from the electronic account corresponding to the first owner of the electronic warehouse receipt to an electronic account corresponding to a second owner of the electronic warehouse receipt.

2. The method of claim 1, where the step of transferring the electronic warehouse receipt from the electronic account corresponding to first owner of the electronic warehouse receipt to an electronic account corresponding to a second owner of the electronic warehouse receipt further comprises responsive to an externally generated request, transferring the electronic warehouse receipt from the electronic account corresponding to first owner of the electronic warehouse receipt to an electronic account corresponding to a creditor of the first owner.

3. The method of claim 1, the method further including the step of responsive to another externally generated request, transferring the electronic warehouse receipt from the electronic account corresponding to the creditor of the first owner of the electronic warehouse receipt to the electronic account of the first owner.

4. The method of claim 1, where each electronic warehouse receipt represents a right to delivery of a predetermined amount of a commodity from an undifferentiated bulk of the commodity.

5. An electronic warehouse receipt system, the system comprising:
means for generating an electronic warehouse receipt record for delivery of a unit of commodity owned by a first party;
means for storing the electronic warehouse receipt in an electronic account corresponding to a first owner of the electronic warehouse receipt;
means for responding to an externally generated request; and
means for transferring the electronic warehouse receipt from the electronic account corresponding to first owner of the electronic warehouse receipt to an electronic account corresponding to a second owner of the electronic warehouse receipt.

6. The electronic warehouse receipt system of claim 5, where the means for transferring the electronic warehouse receipt from the electronic account corresponding to first owner of the electronic warehouse receipt to an electronic account corresponding to a second owner of the electronic warehouse receipt further comprises means for, responsive to an externally generated request, transferring the electronic warehouse receipt from the electronic account corresponding to first owner of the electronic warehouse receipt to an electronic account corresponding to a creditor of the first owner.

7. The electronic warehouse receipt system of claim 5, the system further including means for, responsive to another externally generated request, transferring the electronic warehouse receipt from the electronic account corresponding to the creditor of the first owner of the electronic warehouse receipt to the electronic account of the first owner.

8. A computer system for managing electronic warehouse receipts, the system comprising:
a receipt database for storing electronic warehouse receipts;
a first process means configured to receive trading position data from an electronic trading system and store each trading position record within the trading position data in the database with an initial status of unmatched;
a second process means configured to match buy and sell trade records in the database and, for each matched trade, generate a transaction record for the trade; and
a third process means configured to receive a request for an electronic warehouse receipt from a first party corresponding to a buyer in one of the transaction records and, responsive thereto, generate an electronic warehouse receipt for a unit of commodity corresponding to the transaction record, where the electronic warehouse receipt is stored in the receipt database in a first account corresponding to the first party.

9. The computer system of claim 8, where the third process means is further configured to receive a transfer request from the first party indicating transfer of the electronic warehouse receipt from the first party to a second party and, responsive thereto, transfer the electronic warehouse receipt from the first account to a second account corresponding to the second party.

10. The computer system of claim 9, where the transfer of the electronic warehouse receipt from the first account to the second account represents transfer of ownership of the electronic warehouse receipt.

11. The computer system of claim 8, where the third process means is further configured to perform a predetermined financial check before generating the electronic warehouse receipt and where the electronic warehouse receipt is generated only if the financial check passes.

12. The computer system of claim 11, where the predetermined financial check is based upon reference data regarding a financial condition of a shipping party and all electronic warehouse receipts in an account corresponding to the shipping party.

13. The computer system of claim 8, where the third process means is further configured to process a series of transaction requests involving many electronic warehouse receipts belonging to different parties and, for each transaction, transfer the electronic warehouse receipt in each transaction to an account corresponding to a buying party of the transaction.

14. The computer system of claim 13, where the third process means is further configured to process each transaction request by transferring money from the buying party to a selling party of each transaction.

15. The computer system of claim 8, where each party is enabled to electronically view all electronic warehouse receipts residing in the account corresponding to the party.
